(19) United States
(12) Patent Application Publication
(10) Pub. No.: US 2022/0326780 A1
(43) Pub. Date: Oct. 13, 2022

(54) INFORMATION PROVIDING SYSTEM, INFORMATION PROVIDING METHOD, AND NON-TRANSITORY COMPUTER-READABLE STORAGE MEDIUM

(71) Applicant: NEC Corporation, Tokyo (JP)

(72) Inventors: Akira Kamei, Tokyo (JP); Kenichiro Ida, Tokyo (JP); Itsumi Kato, Tokyo (JP); Tomotaka Suzuki, Tokyo (JP); Tomoko Nishio, Tokyo (JP)

(73) Assignee: NEC Corporation, Tokyo (JP)

(21) Appl. No.: 17/701,885

(22) Filed: Mar. 23, 2022

(30) Foreign Application Priority Data
Apr. 8, 2021 (JP) 2021-065909

(51) Int. Cl. G06F 3/01; G06V 10/22; G06V 40/20; G06Q 30/06

(52) U.S. Cl. CPC G06F 3/017; G06V 10/235; G06V 40/28; G06Q 30/0623

(57) ABSTRACT

An information providing system according to an aspect of the present disclosure is an information providing system for providing product information requested by a store visitor, and includes: a detection unit that detects a finger pointing of a person from an image acquired by an imaging device, a specifying unit that specifies a product from a direction of the finger pointing, and a display unit that displays product information of the specified product in a case where a specified elapsed time exceeds a predetermined time.

This application is based upon and claims the benefit of priority from Japanese Patent Application No. 2021-065909, filed on Apr. 8, 2021, the disclosure of which is incorporated herein in its entirety by reference.

### TECHNICAL FIELD

The present disclosure relates to an information providing system, an information providing method, and a non-transitory computer-readable storage medium.

### BACKGROUND ART

A product presentation method and an information display method are disclosed in which, in a system for managing a product in a store or a displayed product, product presentation for a product picked up by a store visitor approaching a product shelf is executed for the store visitor. Regarding the technique, for example, Japanese Patent Application Laid-open Publication No. 2015-156211 (Patent Literature 1) is referred to.

In the product presentation method and the information display method described in the Patent Literature 1, a technique is disclosed in which the product presentation is performed for the store visitor who does not move from the front of the product shelf after picking up the product to appeal the attraction of the product.

### SUMMARY

One of an object of the present disclosure is to acquire an intention expression to request provision of product information from a store visitor and provide the store visitor with product information in accordance with the intention of the store visitor without touching a product.

According to one aspect of the present disclosure, a system includes: a detection unit that detects a finger pointing of a person from a captured image; a specifying unit that specifies a product from a direction of the finger pointing; and a display unit that displays product information of the specified product on a display device.

According to one aspect of the present disclosure, a method includes: detecting a finger pointing of a person from a captured image; specifying a product from a direction of the finger pointing; and displaying product information of the product on a display device.

According to one aspect of the present disclosure, non-transitory computer-readable storage medium storing a program causing a process to be executed, the process including: detecting a finger pointing of a person by the imaging device; specifying a product from a direction of the finger pointing; and displaying product information of the product specified by the specifying means on a display device.

### BRIEF DESCRIPTION OF THE DRAWINGS

Exemplary features and advantages of the present disclosure will become apparent from the following detailed description when taken with the accompanying drawings in which:

FIG. 1 is a diagram for describing a configuration example of an information providing system in the present example embodiment;

FIG. 2 is a functional configuration diagram of the information providing system according to the present example embodiment;

FIG. 3 is a diagram for describing a usage example of the information providing system in the present example embodiment;

FIG. 4 is a flowchart illustrating a flow of processing of the present example embodiment;

FIG. 5 is an example of a registered image in learning of the present example embodiment;

FIG. 6 is a diagram for describing a processing method of the present example embodiment;

FIG. 7 is a flowchart illustrating a flow of processing of the present example embodiment;

FIG. 8 is an example of a display screen of a display device in the present example embodiment;

FIG. 9 is a diagram for describing a processing method of the present example embodiment;

FIG. 10 is an example of the display screen of the display device in the present example embodiment;

FIG. 11 is a diagram for describing a processing method of the present example embodiment;

FIG. 12 is a flowchart illustrating a flow of processing of the present example embodiment;

FIG. 13 is a diagram for describing a processing method of the present example embodiment;

FIG. 14 is a flowchart illustrating a flow of processing of the present example embodiment;

FIG. 15 is an example of a processing screen of a computer in the present example embodiment;

FIG. 16 is an example of a creation screen of a database according to the present example embodiment;

FIG. 17 is an example of the processing screen of the computer in the present example embodiment;

FIG. 18 is a functional configuration diagram of the information providing system according to the present example embodiment;

FIG. 19 is a flowchart illustrating a flow of processing of the present example embodiment; and

FIG. 20 is an example of a hardware configuration of the information providing system according to the present example embodiment.

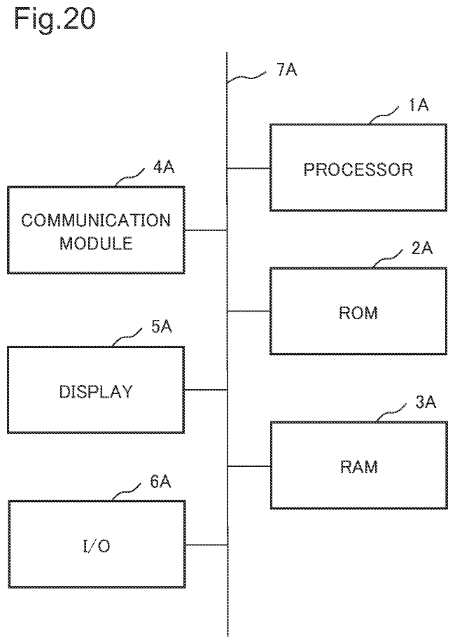

### EXAMPLE EMBODIMENT

First, in order to facilitate understanding of example embodiments of the present disclosure, the background of the present disclosure will be described.

There is a case where it is desired to provide product information while considering prevention of spread of infectious diseases. For example, in a case where a product is touched with a hand to which a virus serving as an infection source of an infectious disease is attached, it is assumed that the virus is attached to the product. In a case where a store visitor who touches a product returns the product to a product shelf without purchasing the product, there is a possibility that a virus attached to the product adheres to a hand of another store visitor who touches the product next and enters a mucous membrane such as a mouth, a nose, and eyes through the hand, and infection may spread.

On the other hand, there is a case where it is desired to check product information before purchasing a product. The product information is, for example, information regarding specific raw materials included in the product, calorie information, or information regarding a best-before date. In many cases, the above-described information is written in small characters on the side surface of the package of the product or the like, and it is necessary to check the product information by picking up the product.

According to the example embodiments of the present disclosure described below, it is possible to provide the store visitors with the product information without extremely approaching the product or touching the product.

Hereinafter, the example embodiments of the present disclosure will be described with reference to the drawings. In the drawings, similar elements or relevant elements are denoted by the same reference numerals, and the description of the elements may be omitted or simplified.

### [Outline of Functions]

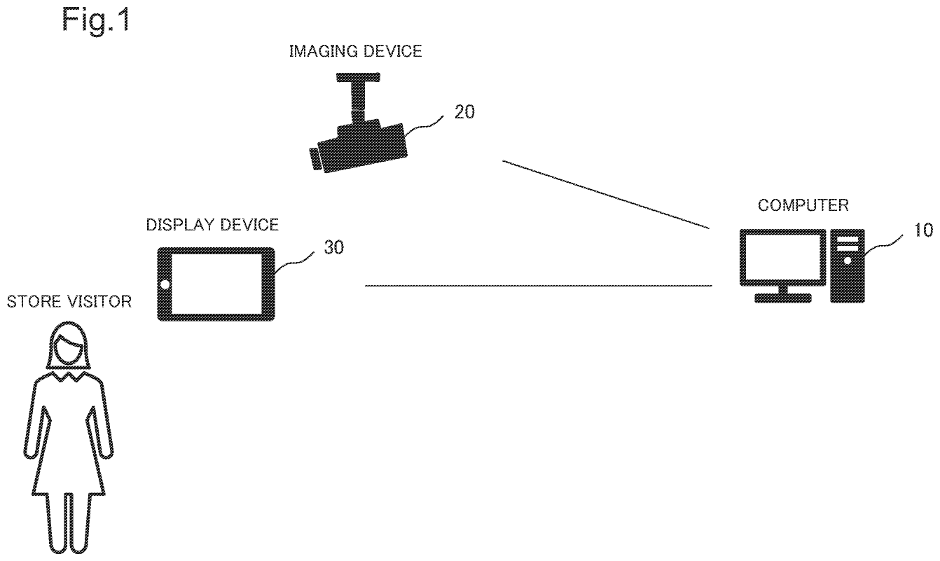

An outline of functions achieved by the present disclosure will be described with reference to FIG. 1. FIG. 1 is a diagram illustrating an example of a situation in which a store visitor acquires information from an information providing system. As illustrated in FIG. 1, the information providing system according to the present example embodiment includes a computer 10, an imaging device 20, and a display device 30.

The computer 10 detects the finger pointing of the store visitor acquired by the imaging device 20 and calculates a finger pointing direction to specify the product for which the store visitor requests information. The computer 10 displays the information regarding the specified product on the display device 30. A finger for finger pointing is not necessarily a fixed finger, and it is sufficient that a direction for specifying the product is clear. A gesture other than finger pointing may be used.

The imaging device 20 is a camera or the like which is installed at a predetermined position or the like and photographs the store visitor or the product shelf in the store. The imaging device 20 may be a camera of which orientation and installation location are fixed, a camera of which orientation can be changed like a pan tilt ZOOM (PTZ) camera, or a movable camera mounted on a moving body. For example, a camera mounted on a wearable terminal such as a smartphone or a tablet may be used. A plurality of dedicated cameras for photographing the finger pointing of a person in the store and a plurality of dedicated cameras for photographing the product shelf may be installed for different purposes. The imaging device 20 and the computer 10 are communicably connected via a random network. The computer 10 and the imaging device 20 may be a single device.

The display device 30 outputs the product information specified from the detected finger pointing direction. For example, the display device may be a tablet installed on the product shelf at a position easily visible to the store visitor, or may be a signage installed near the product shelf. The display device 30 and the computer 10 are communicably connected via a random network. The computer 10, the imaging device 20, and the display device 30 may be a single device.

As described above, in the present example embodiment, it is possible to specify the product by detecting the finger pointing which is the intention expression of the store visitor and acquiring the finger pointing direction, and to provide the product information according to the intention of the store visitor without the store visitor touching the product.

### FIRST EXAMPLE EMBODIMENT

A usage example and an information providing method of the information providing system 1 in the present example embodiment will be described with reference to FIG. 1. The information providing system 1 includes the computer 10, the imaging device 20, and the display device 30. The computer 10 and the imaging device 20 can communicate with each other via wired or wireless communication units provided in the devices. Similarly, the computer 10 and the display device 30 can communicate with each other via wired or wireless communication units provided in the devices. The number of each of the computers 10, the imaging devices 20, and the display devices 30 is at least one or more, and a plurality of computers, imaging devices, and display devices can be simultaneously connected and installed.

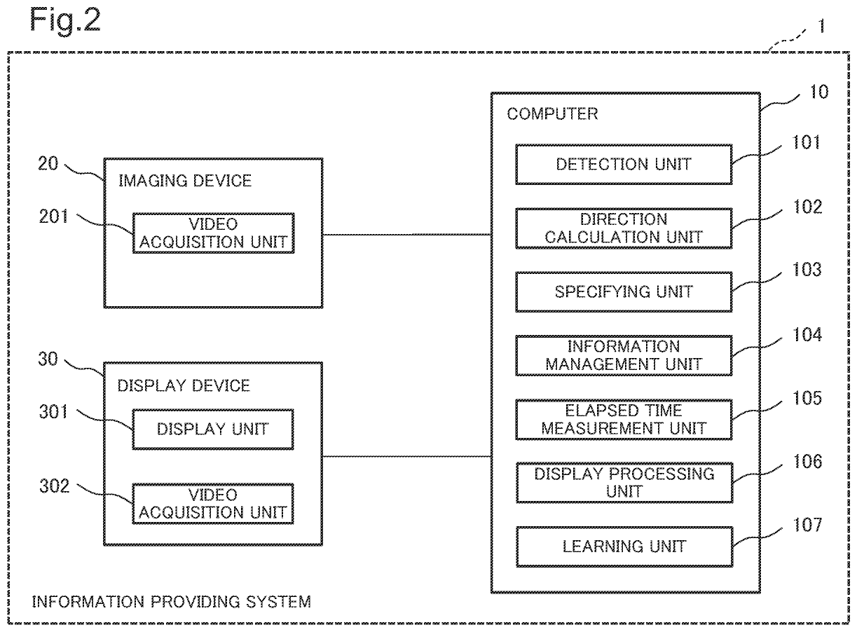

Next, the functional configurations of the computer 10, the imaging device 20, and the display device 30 will be described with reference to FIG. 2. The computer 10 includes a detection unit 101, a direction calculation unit 102, a specifying unit 103, an information management unit 104, an elapsed time measurement unit 105, a display processing unit 106, and a learning unit 107. The imaging device 20 includes a video acquisition unit 201, and the display device 30 includes a display unit 301 and a video acquisition unit 302. The detection unit 101 serves as a detection means for detecting a finger pointing of a person from an image acquired from the imaging device 20. The direction calculation unit 102, the specifying unit 103, the information management unit 104, the elapsed time measurement unit 105, and the learning unit 107 serve as a specifying means for specifying a product from a finger pointing direction. The display processing unit 106 serves as a display means for displaying the product information of the specified product on the display device 30.

The detection unit 101 automatically identifies and detects a finger pointing or other hand gestures from the image acquired from the video acquisition unit 201. Specifically, the finger pointing is identified by any of various known methods or a combination of the methods. For example, machine learning type image analysis can be used. In the video analysis of machine learning, the finger pointing in a video image is automatically and efficiently identified by an image recognition technique using deep learning. A place where detection unit 101 detects the finger pointing is not limited to the front of the product shelf as long as the place is in the image acquired by the video acquisition unit 201, and the finger pointing is detected even when the finger pointing is performed behind another store visitor. Since it is sufficient that the finger pointing of the store visitor is detected, a part of the body (such as a head and a torso) other than the finger pointing may not be photographed in the image.

The direction calculation unit 102 serves as a direction calculation means for calculating the direction of the finger indicated by the finger pointing detected by the detection unit 101. For example, the joint points of the finger of the finger pointing detected by the detection unit 101 are extracted using a joint estimation technique (skeleton estimation technique) such as Open Pose using machine learning. The direction calculation unit 102 generates a straight line connecting a first joint point and a second joint point of the finger which are extracted, and calculates a finger pointing direction toward the product by extending the straight line in a direction away from the body. The length of the straight line generated by the direction calculation unit 102 may be set as a variable value according to the positions of the store visitor and the product shelf or a fixed value. The straight line is generated even in a case where another store visitor exists in front of the product shelf, and the store visitor who performs finger pointing is not at a position closest to the product shelf and in front of the product shelf. The generated straight line is extended in the direction away from the body of the store visitor who requests information provision regardless of the presence or absence of the another store visitor, and the direction calculation unit 102 calculates the finger pointing direction toward the product.

The specifying unit 103 extracts the object area of the product from the acquired video by image processing. And in a case where the straight line generated by the direction calculation unit 102 intersects the object area, the specifying unit 103 specifies the product in the object area intersecting the straight line by using image recognition. The object area of the product is a processing area obtained by cutting out the area of the object from the image for easy image recognition. In specifying the product, the product is specified when the image of the product appearance in the extracted object area is image recognized by using the product appearance data managed by the information management unit 104. In a case where the intersection is made across the object areas of a plurality of products, and one product cannot be specified, two products may be specified as information provision products. The object area may be a rectangle surrounding the product, a circle surrounding the product, or an outer shape of the product.

The information management unit 104 is a database for storing the product information of the purchased product. As the product information, information such as an appearance photograph of a product, a product name, a product type, a specific raw material, a best-before date, a price, and calories is stored. The product information is not limited to the above.

The elapsed time measurement unit 105 counts an elapsed time in which the straight line generated by the direction calculation unit 102 intersects the object area of the product. The elapsed time measurement unit 105 stops counting when the intersection between the straight line and the object area of the product deviates.

When a predetermined time has elapsed since the elapsed time measurement unit 105 started counting, the display processing unit 106 displays the product information specified by the specifying unit 103 on the display unit 301. In a case where a plurality of display devices 30 is installed on the product shelf, the display device 30 is selected according to the position and height of the store visitor in the store, and the product information is displayed. In a case where the amount of information to be displayed, such as an appearance photograph of a product, a product name, a product type, a specific raw material, a best-before date, a price, and calories, is large, the display processing unit 106 may switch display contents at predetermined time intervals.

The learning unit 107 learns finger pointing or other hand gestures. The learning unit 107 may learn not only the finger pointing which is the intention expression of the store visitor requesting the acquisition of the product information but also an action of waving a hand which is the intention expression to cancel the display in a case where the product information different from the intended product is displayed. In a case where the specifying unit 103 specifies two products as candidates, the appearances and product names of the two products may be displayed on the display unit 301, and the learning unit 107 may learn a gesture of the store visitor selecting a product for which information is desired to be provided.

The video acquisition unit 302 is provided in the display device 30, and acquires a gesture which is the intention expression of the store visitor.

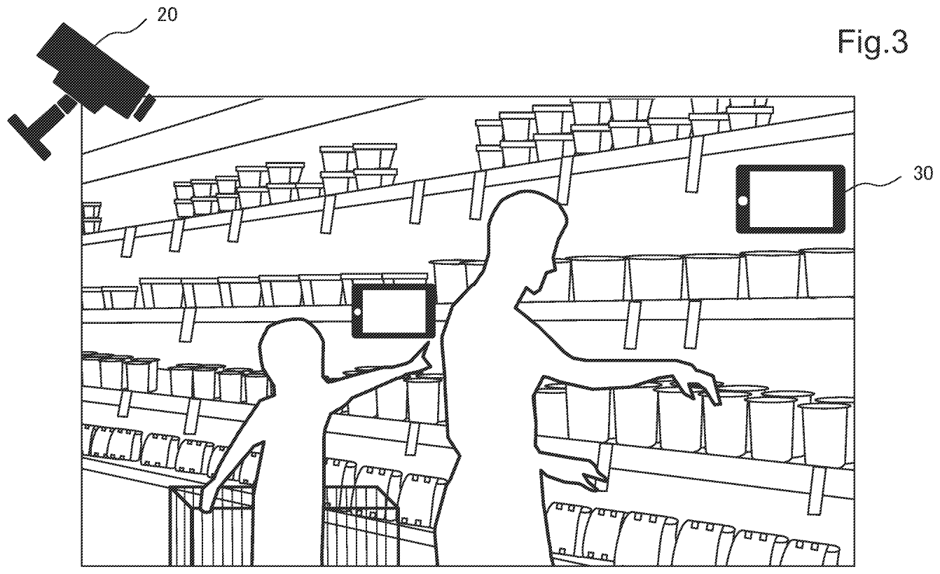

FIG. 3 is a diagram for describing a usage example of the information providing system in the present example embodiment. The imaging device 20 is installed at a position that allows the imaging device to photograph the product shelf In FIG. 3, the imaging device is installed near the ceiling that allows the imaging device to photograph the product shelf, but in installation position, a plurality of imaging devices may be installed directly on the upper portion of the product shelf. The display device 30 is installed at a position that allows the store visitor to easily see the display device and the display device to easily detect the gesture of the store visitor. The display device may be installed at a position below the product shelf on the assumption that a short store visitor uses the display device.

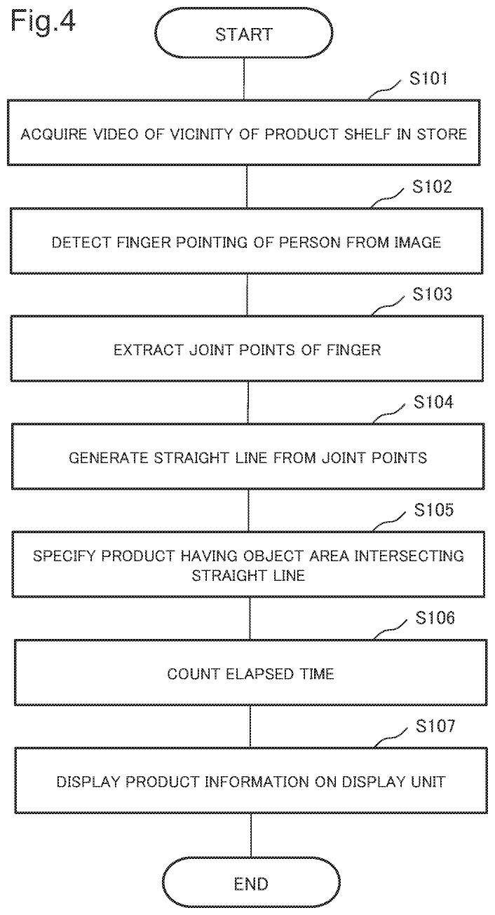

FIG. 4 is a flowchart of the information providing system illustrating a flow of processing of the present example embodiment from when the video acquisition unit 201 acquires the image to when the product is specified according to the finger pointing which is intention expression of the store visitor and displayed on the display unit 301. First, the imaging device 20 installed in the store acquires the image of the vicinity of the product shelf (S101). The detection unit 101 detects the finger pointing of the store visitor from the acquired image (S102). The direction calculation unit 102 extracts the first joint point and the second joint point of the finger of the finger pointing detected by the detection unit 101 (S103). The direction calculation unit 102 generates a straight line connecting the first joint point and the second joint point which are extracted, and calculates a direction toward the product by extending the straight line in a direction away from the body (S104).

The specifying unit 103 extracts the object area of the product from the acquired image by image processing, and in a case where the straight line generated by the direction calculation unit 102 intersects the object area, specifies the product by using image recognition (S105). The elapsed time measurement unit 105 counts an elapsed time in which the straight line generated by the direction calculation unit 102 intersects the object area of the product (S106). When a predetermined time has elapsed since the elapsed time measurement unit 105 started counting, the display processing unit 106 displays the product information specified by the specifying unit 103 on the display unit 301 (S107). In the above flowchart, the elapsed time in which the straight line intersects the object area of the product is counted after the product having the object area intersecting the straight line is specified, but conversely, the product may be specified in a case where the elapsed time of the intersecting exceeds a predetermined time.

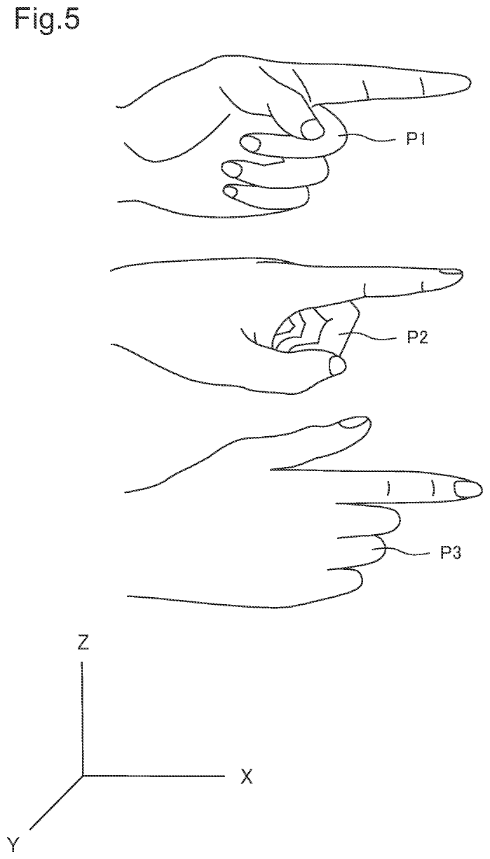

FIG. 5 is an image example of the finger pointing of a person to be learned by the learning unit 107. The finger pointing photographed from various directions is learned. For example, FIG. 5 illustrates finger-pointing images (P1 to P3) captured from a Y-axis direction. P1 is an image captured from an angle at which the palm faces the front, and P3 is an image captured from an angle at which the back of the hand faces the front. P2 is captured at an angle between P1 and P3, and the thumb side is the front. When the finger pointing angle of P1 is defined as 0° on a XZ plane, P3 is 180° and P2 is 90°. The learning unit learns the finger pointing for all angles from 0° to 360°. The finger pointing is learned at all angles from 0° to 360° not only in photographing from the Y-axis direction but also in photographing from an X-axis direction and a Z-axis direction. The detection unit 101 detects a finger pointing from the image acquired by the video acquisition unit 201 by using the finger pointing learned by the learning unit 107.

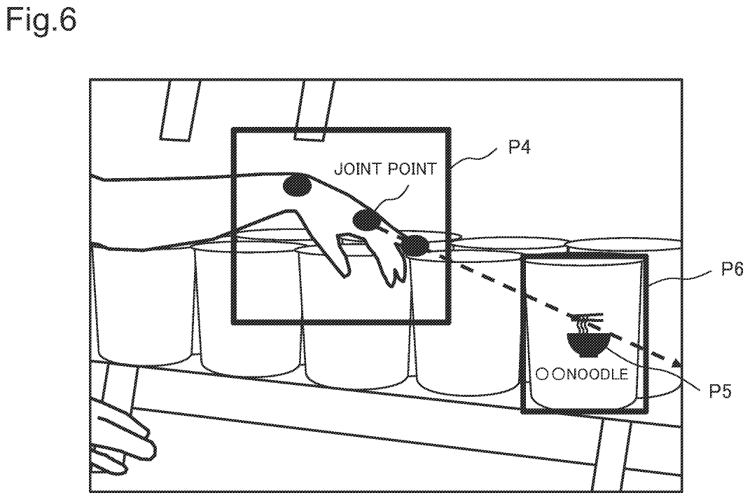

FIG. 6 is a diagram illustrating an example in which the detection unit 101 detects the finger pointing, and the direction calculation unit 102 calculates the finger pointing direction. The detection unit 101 detects the finger pointing and extracts an object area P4 of the finger pointing. The direction calculation unit 102 extracts the joint points of the detected finger pointing in the object area P4 by using a joint estimation technique such as Open Pose, generates a straight line connecting the first joint point and the second joint point of the finger, and further extends the straight line to the product side. The specifying unit 103 specifies a product having the object area intersecting the straight line.

The specifying unit 103 identifies a product appearance P5 from the image acquired from the video acquisition unit 201, and specifies the product by collating with the product appearance stored in the product database of the information management unit 104. The specifying unit 103 sets an area surrounding the specified product appearance as an object area P6 of the product. The size of the area may be incorporated into a program to be defined by the size of the product, or may be designed to be directly input to the system.

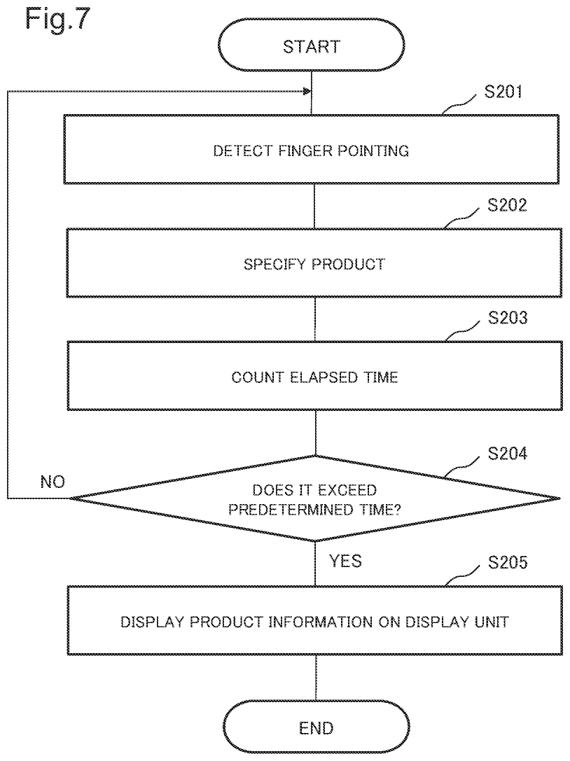

FIG. 7 is a flowchart illustrating a processing example in a case where the elapsed time measurement unit 105 starts counting. First, the detection unit 101 detects the finger pointing (S201). Next, the specifying unit 103 specifies the product (S202). The elapsed time measurement unit 105 counts a time in which the straight line generated by the direction calculation unit 102 intersects the object area of the product after the product is specified (S203). In a case where the elapsed time exceeds the predetermined time, the product information is displayed on the display unit 301 (S204; YES, S205). On the other hand, in a case where the straight line deviates from the object area of the product before the elapsed time reaches the predetermined time, the processing returns to the state before the finger pointing is detected (S204; NO).

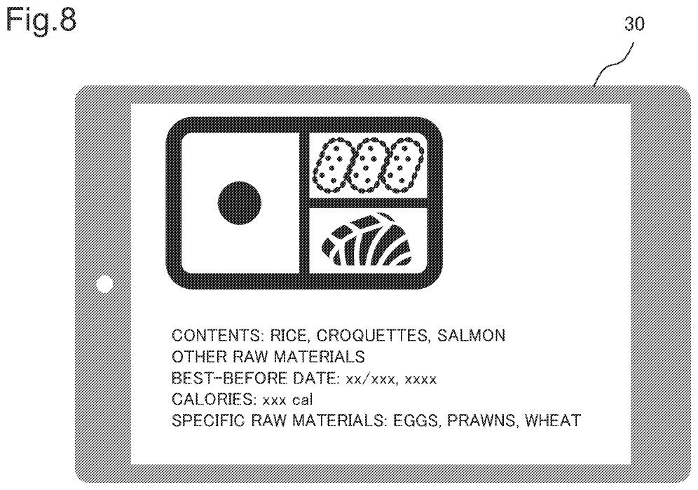

FIG. 8 is a display example in which the product information of the specified product is displayed on the display unit 301 of the display device 30. The display unit 301 displays an appearance photograph, a product name, a product type, a specific raw material, a best-before date, a price, calories, and the like when the product is viewed from above or sideways. Discount information, campaign information, and the like in the case of purchasing at the same time with other products may be displayed. When the amount of information to be displayed is large, the display content may be switched and displayed at predetermined time intervals. The product information may be provided not only by display but also by voice.

As described above, according to the information providing system of the present example embodiment, it is possible to acquire the intention expression of the store visitor and provide the product information requested by the store visitor without the store visitor touching the product. For example, even in a case where another store visitor exists in front of the product shelf, and the store visitor who requests the product information is not at a position closest to the product shelf in front of the product shelf, the product information can be displayed on the display unit 301 by finger pointing.

### SECOND EXAMPLE EMBODIMENT

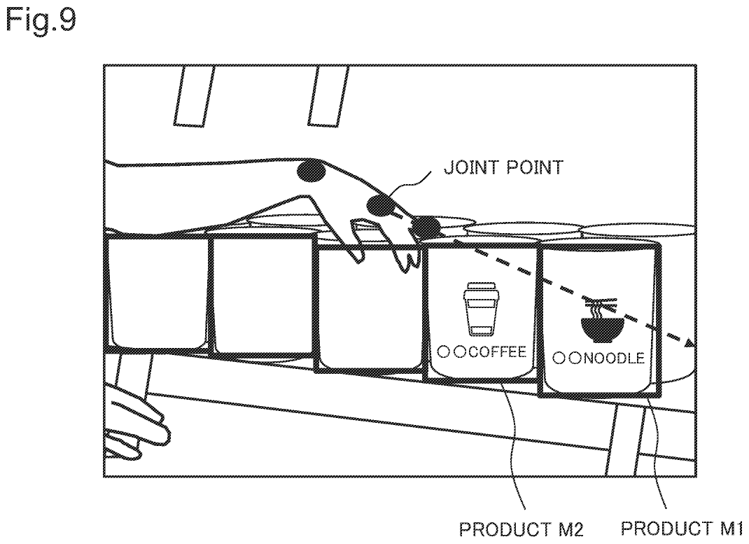

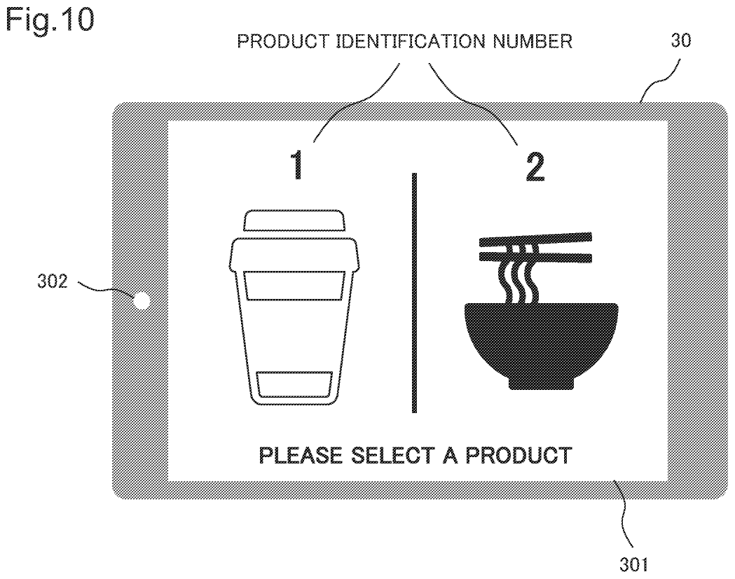

Next, another example applicable to the first example embodiment will be described with reference to FIGS. 9 and 10. In the first example embodiment, the method for specifying the product in which the straight line generated by the direction calculation unit 102 intersects the object area of one product has been described. In a second example embodiment, a product specifying method in a case where the straight line intersects a plurality of object areas having different product names will be described in detail. As illustrated in FIG. 9, when the straight line generated by the direction calculation unit 102 intersects the object areas of two products of a product M1 and a product M2, the specifying unit 103 specifies the two products and displays the specified products on the display unit 301.

FIG. 10 is a display example in which two products having different product names are displayed on the display unit 301. In the display, information such as the product image and product name of the specified product is provided, and product identification numbers indicating the respective products are displayed above the information. The specifying unit 103 displays words instructing to select one of the two products specified based on the finger pointing of the store visitor. These words and identification numbers may be displayed on the display unit 301 as described above, or may be notified by voice.

The display device 30 includes a video acquisition unit 302, and the store visitor who requests information provision by finger pointing selects a product for which information is desired to be provided by showing a gesture indicating a product identification number toward the video acquisition unit 302. The gesture indicating the product identification number may be expressed by, for example, raising one finger in the case of 1 and raising two fingers in the case of 2, and the learning unit 107 defines the meaning of the expression. The detection unit 101 detects the finger pointing from the image acquired by the video acquisition unit 201 of the imaging device 20, and detects the gesture indicating the product identification number from the image acquired by the video acquisition unit 302 of the display device 30. The display unit 301 displays the product information relevant to the product identification number indicated by the gesture of the store visitor. In FIG. 10, a case where the straight line intersects two different products of the product M1 and the product M2 has been described. On the other hand, in a case where the object areas of the two products intersecting the straight line are products having the same product name, the product information is provided without displaying the display screen for instructing selection as illustrated in FIG. 10.

As described above, even in a case where the straight line intersects object areas of a plurality of products due to an imaging position of the imaging device 20, it is possible to select one product for which the store visitor desires to be provided with information, and it is possible to appropriately provide information in response to the intention of the store visitor.

### THIRD EXAMPLE EMBODIMENT

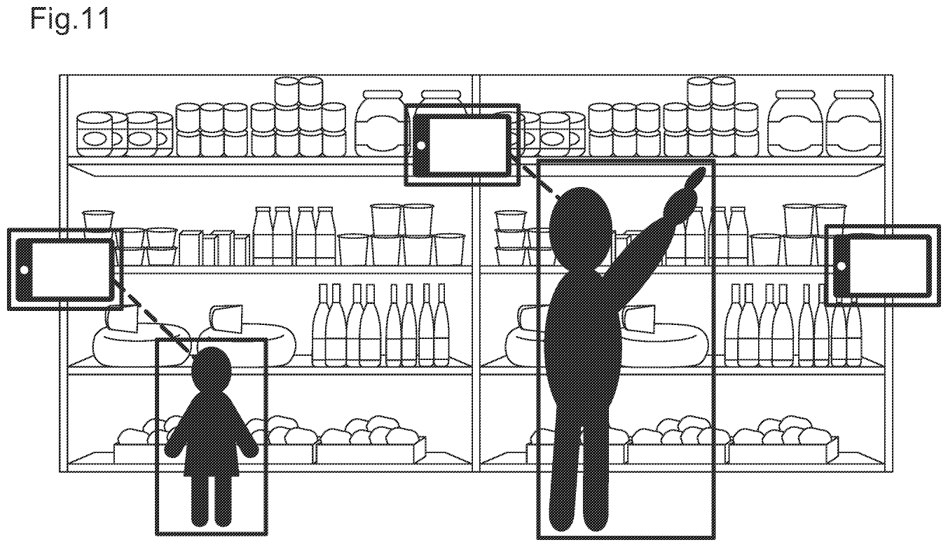

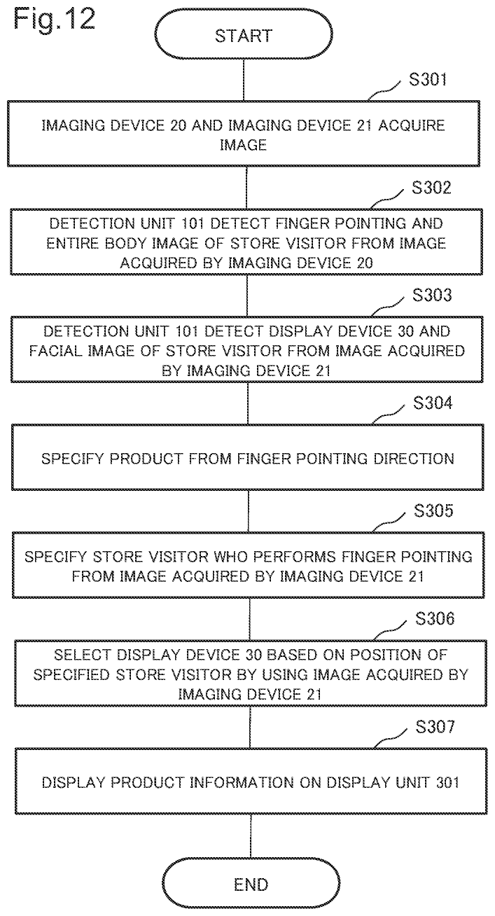

Next, another example applicable to the first example embodiment will be described with reference to FIGS. 11 and 12. In the first example embodiment, the method has been described in which the imaging device 20 is installed near the ceiling to allow the imaging device to photograph the product shelf, the finger pointing of the store visitor is detected, the product is specified based on the finger pointing direction, and the product information is displayed on the display unit 301. In a third example embodiment, a method will be described in which the display device 30 which is easily viewable by the store visitor is selected among a plurality of display devices 30 at the time of display on the display unit 301.

In the first example embodiment, a video is acquired from the imaging device 20 which is installed in the vicinity of the ceiling that allows the finger pointing to be easily detected in order to detect the finger pointing of the store visitor. In the present example embodiment, a video is also acquired from an imaging device 21 (not illustrated) installed near the front of the product shelf FIG. 11 is an example of the image captured by the imaging device 21. The store visitor and the display device 30 are detected from the image captured by the imaging device 21.

FIG. 12 is a flowchart illustrating a flow of processing of the present example embodiment from when a video is acquired by the imaging device 20 and the imaging device 21 to when a product is specified according to the finger pointing which is the intention expression of the store visitor and displayed on the display unit 301. First, the imaging device 20 installed near the ceiling acquires the video of the vicinity of the product shelf, and the imaging device 21 acquires the image of the product shelf captured from the front (S301).

The detection unit 101 detects the finger pointing and the entire body image of the store visitor from the image acquired by the imaging device 20 (S302). The detection unit 101 detects the display device 30 and the entire body image of the store visitor from the image acquired by the imaging device 21 (S303). The display device 30 and the entire body image are learned in advance by the learning unit 107, and the entire body and the display device 30 are detected using image recognition. With the same method as that of the first example embodiment, the specifying unit 103 generates a straight line from the finger pointing direction, and specifies a product appearance in the object area intersecting the straight lines by image recognition (S304).

The display processing unit 106 collates the entire body image of the store visitor who performs the finger pointing detected from the image acquired from the imaging device 20 with the entire body image of the store visitor detected from the image acquired by the imaging device 21. By the collating, the display processing unit 106 specifies the store visitor who performs the finger pointing from the image acquired by the imaging device 21 (S305). Based on the image acquired by the imaging device 21, the display processing unit 106 selects the display device 30 which displays the specified product information based on the position of the specified store visitor and the installation position of the detected display device 30 (S306). The display processing unit 106 displays the product information of the specified product on the display unit 301 of the display device 30 selected from the plurality of display devices 30 (S307).

For example, as a means which selects the display device 30 which displays the product information from the plurality of display devices 30, the display processing unit 106 makes selection in such a way that a linear distance from the position of the store visitor to the installation position of the display device 30 is the shortest. In the case of a short store visitor, the display device 30 installed at a low position may be selected. In a case where the display device 30 is providing the product information by the finger pointing of another store visitor, the product information may be displayed on the display device 30 having the linear distance second closest to the position of the store visitor.

In the present example embodiment, the imaging device 20 and the imaging device 21 are used, but when an image is captured in a wide range and the positions of a plurality of display devices 30 and the store visitor can be recognized by one imaging device, the imaging may be performed only by the imaging device 20. In this case, it is not always necessary to detect the entire body of the store visitor, and by detecting the finger pointing and the display devices 30, an appropriate display device is selected from the plurality of display devices 30 based on the positions of the display devices 30 and the finger pointing of the store visitor.

As described above, the store visitor can check the product information from the display device 30 close to the position where the store visitor is present. When the display device 30 is selected according to the height, the store visitor can easily check the display device 30.

### FOURTH EXAMPLE EMBODIMENT

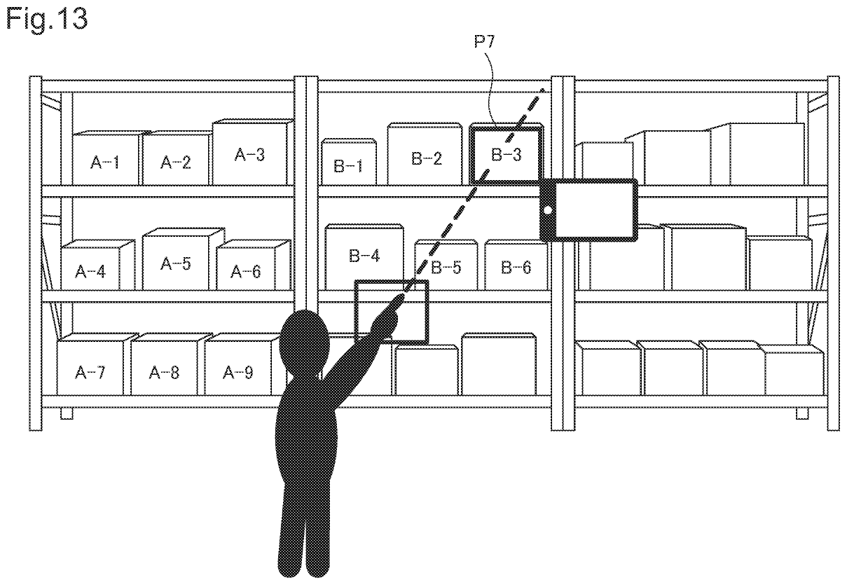

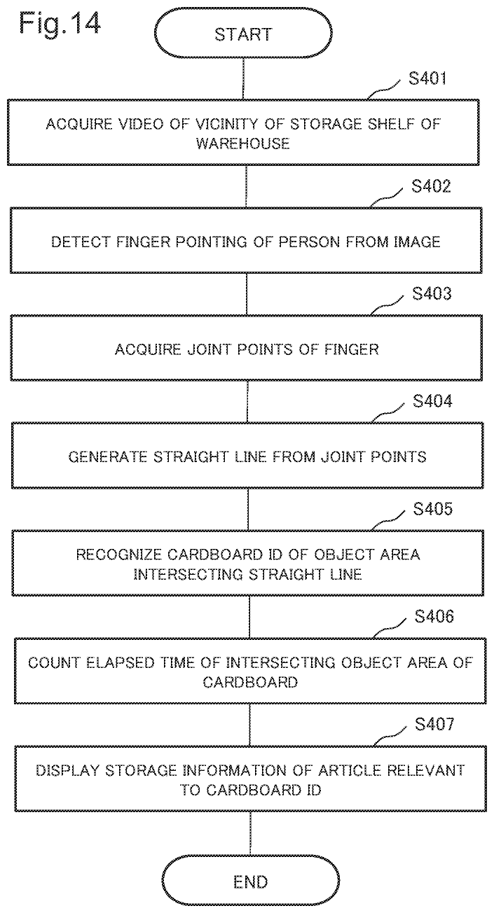

Next, another embodiment applicable to the first example embodiment will be described with reference to FIGS. 13 and 14. In the first example embodiment, it is assumed that the store visitor requests the information of the product in the store, and the product information specified based on the finger pointing of the store visitor is displayed on the display unit 301. In a fourth example embodiment, a method will be described in which, in a case where an article is stored in a cardboard or the like of which inside is not visible in a warehouse, the storage information of the article in the cardboard specified based on the finger pointing by a person is displayed on the display unit 301.

FIG. 13 is a diagram illustrating an example in which a finger pointing is detected from the image acquired by the imaging device 20 which photographs the vicinity of the warehouse shelf installed in the warehouse, a cardboard of which the inside is desired to be checked is specified from the finger pointing direction, and article information is displayed on the display unit 301. A cardboard ID for managing a cardboard is written on the side surface of the cardboard that can be checked from the imaging device 20.

As in the first example embodiment, the detection unit 101 detects a finger pointing from the image acquired by the imaging device 20. The direction calculation unit 102 calculates a finger pointing direction. In the information management unit 104, the information of the article stored in advance in the cardboard relevant to the cardboard ID is registered by using an input device such as a mouse. The article information is the photograph of the inside of a cardboard box, an article name, a model name, a number, a consumption expiration date, and the like. The specifying unit 103 extracts an object area P7 of the cardboard by image processing from the image acquired by the video acquisition unit 201, and when the straight line generated by the direction calculation unit 102 intersects the object area P7, recognizes the cardboard ID of the object area by using image recognition. The specifying unit 103 acquires the information of the article in the cardboard relevant to the recognized cardboard ID from the information management unit 104. The display processing unit 106 displays the information of the article in the cardboard ID specified by the specifying unit 103 on the display unit 301.

FIG. 14 is a flowchart illustrating a flow of processing of the present example embodiment from when the imaging device 20 acquires a video to when a cardboard ID is recognized in accordance with the finger pointing which is the intention expression of a manager, and the storage information of the article corresponding to the cardboard ID is displayed on the display unit 301. First, the imaging device 20 installed near the ceiling acquires the video of the vicinity of a storage shelf (S401). The detection unit 101 detects the finger pointing of the person from the acquired video (S402). The direction calculation unit 102 extracts the first joint point and the second joint point of the finger of the finger pointing detected by the detection unit 101 (S403). The direction calculation unit 102 generates a straight line connecting the first joint point and the second joint point which are extracted, and calculates a direction toward the cardboard by extending the straight line in a direction away from the body (S404).

The specifying unit 103 extracts the object area of the cardboard by image processing from the image acquired by the video acquisition unit 201, and when the straight line generated by the direction calculation unit 102 intersects the object area P7, recognizes the cardboard ID of the object area by using image recognition (S405). The specifying unit 103 acquires the information of the article in the cardboard relevant to the recognized cardboard ID from the information management unit 104. The elapsed time measurement unit 105 counts an elapsed time in which the straight line generated by the direction calculation unit 102 intersects the object area P7 of the cardboard (S406). When a predetermined time has elapsed since the elapsed time measurement unit 105 started counting, the display processing unit 106 displays the article storage information of the cardboard ID specified by the specifying unit 103 on the display unit 301 (S407).

As described above, according to the present example embodiment, even in a case where an article is stored in a cardboard box or the like of which inside is not visible, it is not necessary to unload the cardboard box from the storage shelf and open the inside, and it is possible to efficiently check the article information.

### Modification

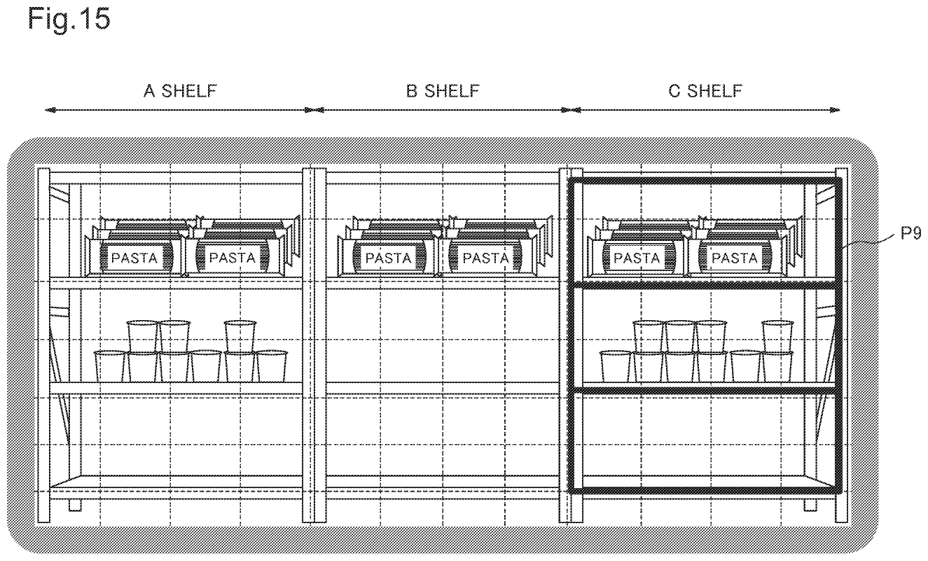

In the first to fourth example embodiments described above, when a product is specified, the product is specified by performing image recognition on the image of the product appearance acquired by the imaging device 20 and the product appearance managed by the information management unit 104. In the present modification, a method of specifying a product without using image recognition will be described with reference to FIGS. 15 to 17. The processing from the detection of the finger pointing from the image acquired by the imaging device 20 to the generation of the straight line from the joint points is similar to that in the first example embodiment (FIGS. 4; S101 to S104).

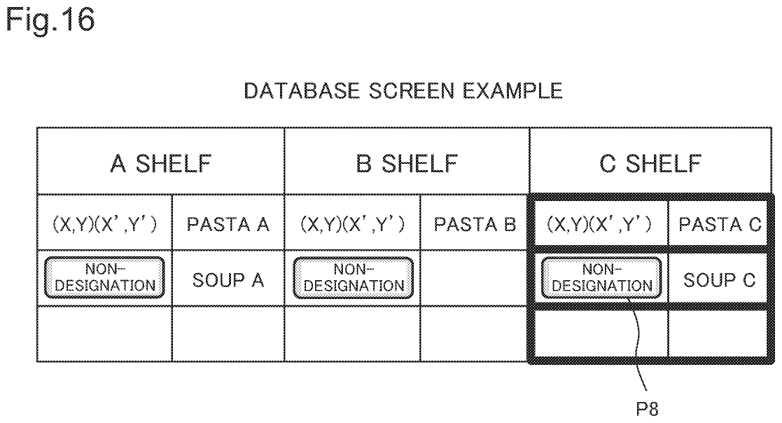

FIG. 15 is an example of a processing screen in which grid-shaped lines indicating the X axis and the Y axis are superimposed and displayed on the image acquired by the imaging device 20. FIG. 16 is a screen example of the database which is the information management unit 104 and stores the product information of the purchased product. For example, in a C shelf of FIG. 15, pasta C is displayed on the uppermost shelf, and soup C is displayed on the second shelf from the top. In a case where the manager of the store desires to designate the position of the soup C on the screen, when a non-designation button P8 of FIG. 16 is pressed by using an input device such as a mouse, an area P9 can be designated on the processing screen of FIG. 15. The information management unit 104 recognizes the coordinates designated by the manager and registers the coordinates in the database. Accordingly, the position at which the soup C is on the screen coordinates is recognized in the system, and the area P9 is set as the object area as with the other example embodiments.

The specifying unit 103 acquires the information of the product having the object area intersecting the straight line generated by the direction calculation unit 102 from the database of the information management unit 104, and displays the product information on the display unit 301.

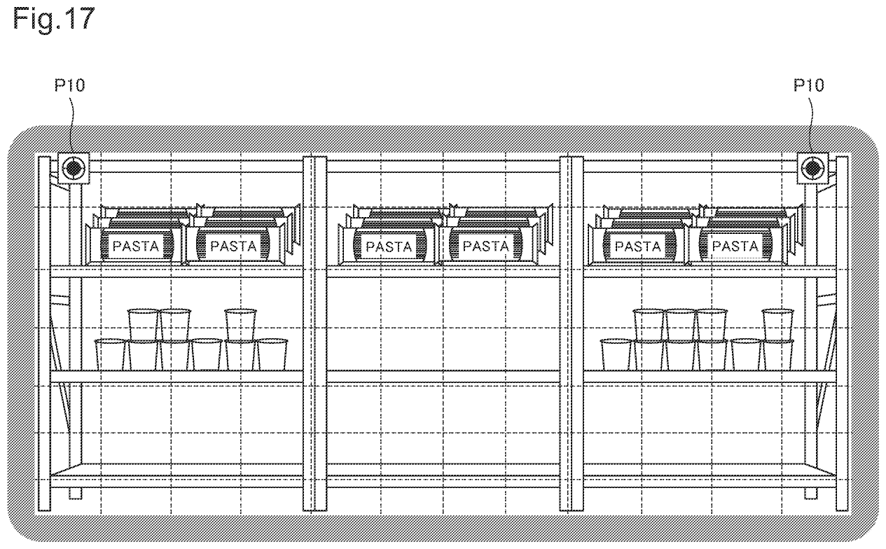

FIG. 17 is a diagram for describing positioning of a captured image of the imaging device 20. On the product shelf, an alignment mark P10 is placed at a position easily recognized by the imaging device 20. The imaging device 20 automatically controls the pan and tilt of a camera in such a way that the alignment marks appear on predetermined coordinates of the screen coordinates. Accordingly, even in a case where the imaging device 20 is not fixed, the position of the product can be grasped, and the product information can be managed in the database.

As described above, it is possible to specify a product without using image recognition.

### FIFTH EXAMPLE EMBODIMENT

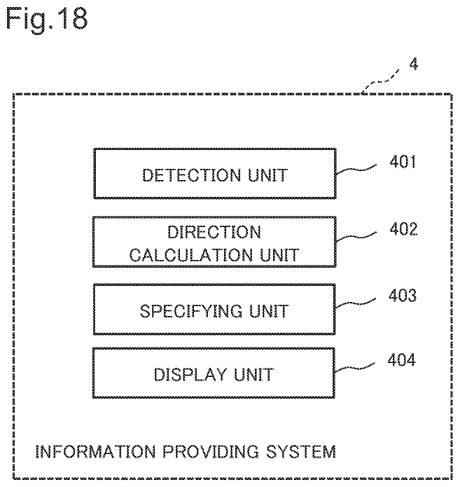

The minimum configuration of an information providing system 4 in the present disclosure will be described with reference to FIG. 18. FIG. 15 is a diagram illustrating an overall configuration example of the information providing system 4 in the present example embodiment. The information providing system 4 includes a detection unit 401, a direction calculation unit 402, a specifying unit 403, and a display unit 404.

The detection unit 401 detects the finger pointing of the person near the product shelf in the store by using the imaging device 20. The direction calculation unit 402 calculates the finger pointing direction of the store visitor detected by the detection unit 401. The specifying unit 403 specifies a product from the finger pointing direction calculated by the direction calculation unit 402. The display unit 404 displays the information of the product specified by the specifying unit 403.

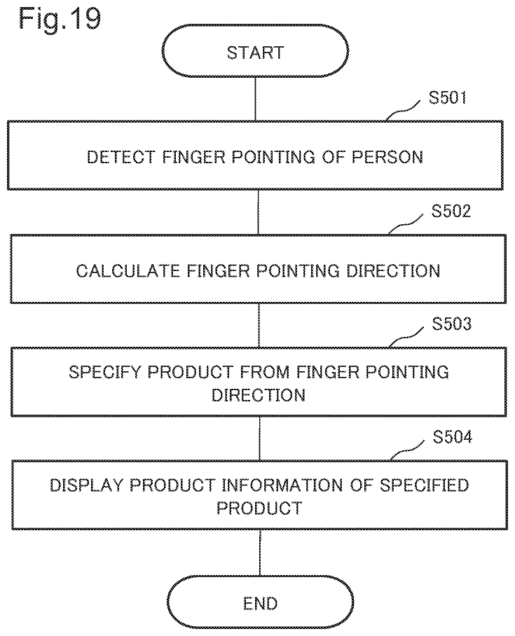

Next, a flow of processing related to the minimum configuration of the information providing system 4 will be described with reference to FIG. 19. The detection unit 401 detects the finger pointing of the store visitor near the product shelf in the store by using the imaging device 20 (S501). The direction calculation unit 402 calculates the finger pointing direction of the person detected by the detection unit 401 (S502). The specifying unit 403 specifies a product from the finger pointing direction calculated by the direction calculation unit 402 (S503). The display unit 404 displays the information of the product specified by the specifying unit 403 (S504).

As described above, the store visitors can acquire the product information without touching the product by performing the intention expression to desire to be provided with the product information by the information providing system using the computer 10.

### HARDWARE CONFIGURATION EXAMPLE

Next, an example of a hardware configuration for achieving the computer 10, the imaging device 20, the display device 30, and the information providing system (1, 4) in each of the above-described example embodiments will be described. Each functional unit (the detection unit 401, the direction calculation unit 402, the specifying unit 403, the display unit 404, and the like) included in the computer 10, the imaging device 20, the display device 30, and the information providing system (1, 4) is achieved by a random combination of hardware and software mainly including at least one central processing unit (CPU) of a random computer, at least one memory, a program loaded into the memory, at least one storage unit such as a hard disk storing the program, an interface for network connection, and the like. It will be understood by those skilled in the art that there are various modifications of this achieving method and device. The storage unit can also store a program downloaded from a storage medium such as an optical disk, a magneto-optical disk, and a semiconductor flash memory, a server on the Internet, or the like in addition to a program stored before shipment of the device.

A processor (1A) is, for example, an arithmetic processing device such as a CPU, a graphics processing unit (GPU), and a microprocessor, and executes various programs and controls each unit. That is, the processor (1A) reads a program from a ROM (2A) and executes the program by using a RAM (3A) as a work area. In the above example embodiments, an execution program is stored in the ROM (2A).

The ROM (2A) stores the execution program for causing the processor (1A) to execute a detection process of detecting a finger pointing of a person from a captured image, a specifying process of specifying a product from a direction of the finger pointing, and a display process of displaying product information of the specified product on a display device. Also, the ROM (2A) stores data related to the product information and learning information of the finger pointing. The RAM (3A) as the work area temporarily stores the program or data.

A communication module (4A) achieves a function of the computer 10 mutually communicating with the imaging device 20 and the display device 30. In a case where a plurality of computers 10 are installed, a function of mutual communication between the computers is achieved.

A display (5A) functions as a display unit, and has a function of inputting a request from the user with a touch panel, a mouse, or the like, displaying a response from the information providing system (1, 4), and displaying product information.

An I/O (6A) includes an interface for acquiring information from an input device, an external device, an external storage unit, an external sensor, a camera, and the like, an interface for outputting information to an output device, an external device, an external storage unit, and the like, and the like. Examples of the input device include a touch panel, a keyboard, a mouse, a microphone, and a camera. Examples of the output device include a display, a speaker, a printer, and a lamp.

As compared with the example embodiment described above, in Japanese Patent Application Laid-open Publication No. 2015-156211, the intention expression of the store visitors to request the provision of the product information is not acquired, and the related information is displayed according to the action of picking up the product. According to the present disclosure, it is possible to provide the information providing system, the information providing method, and the non-transitory computer-readable storage medium that acquire the intention expression of the store visitor to request the provision of the product information without the store visitor touching the product and provide the product information to the store visitor.

The configurations of the above-described example embodiments may be combined, or some components may be interchanged. The configuration of the present disclosure is not limited only to the above-described example embodiments, and various modifications may be made without departing from the gist of the present disclosure.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information providing system comprising:
a memory; and
at least one processor coupled to the memory,
the at least one processor performing operations to:
detect a finger pointing of a person from a captured image;
specify a product from a direction of the finger pointing; and
display product information of the specified product on a display device.

2. The information providing system according to claim 1, wherein the at least one processor further performs operation to:
detect the finger pointing by learning the finger pointing.

3. The information providing system according to claim 1, wherein the at least one processor further performs operation to:
calculate the direction of the finger pointing by generating a straight line from the finger pointing.

4. The information providing system according to claim 3, wherein the at least one processor further performs operation to:
extract an object area from the image and specify a product having the extracted object area intersecting the straight line.

5. The information providing system according to claim 1, wherein the at least one processor further performs operation to:
select a display device which displays product information of the specified product from a plurality of the display devices based on a position of a store visitor who performs the finger pointing.

6. An information providing method comprising:
detecting a finger pointing of a person from a captured image;
specifying a product from a direction of the finger pointing; and
displaying product information of the specified product on a display device.

7. The information providing method according to claim 6, wherein
in the detecting, the finger pointing is detected by learning the finger pointing.

8. The information providing method according to claim 6, further comprising:
calculating the direction of the finger pointing by generating a straight line from the finger pointing.

9. The information providing method according to claim 8, wherein
in the specifying, an object area is extracted from the image, and a product having the extracted object area intersecting the straight line is specified.

10. The information providing method according to claim 6, wherein
in the displaying, a display device which displays product information of the specified product is selected from a plurality of the display devices based on a position of a store visitor who performs the finger pointing.

11. A non-transitory computer-readable storage medium storing a program for causing a processor of a computer to execute a process comprising:
detecting a finger pointing of a person from a captured image;
specifying a product from a direction of the finger pointing; and
displaying product information of the specified product on a display device.

12. The non-transitory computer-readable storage medium according to claim 11, wherein
in the detecting, the finger pointing is detected by learning the finger pointing.

13. The non-transitory computer-readable storage medium according to claim 11, wherein
the direction of the finger pointing is calculated by generating a straight line from the finger pointing.

14. The non-transitory computer-readable storage medium according to claim 13, wherein
in the specifying, an object area is extracted from the image, and a product having the extracted object area intersecting the straight line is specified.

15. The non-transitory computer-readable storage medium according to claim 11, wherein
in the displaying, a display device which displays product information of the specified product is selected from a plurality of the display devices based on a position of a store visitor who performs the finger pointing.
